(19) United States
(12) Patent Application Publication
(10) Pub. No.: US 2023/0384579 A1
(43) Pub. Date: Nov. 30, 2023

(54) METHODS AND SYSTEMS OF MECHANICAL TUNING MULTI CHANNEL OPTICAL COMPONENTS

(71) Applicants: MOHAMMADREZA FASIHANIFARD, MONTREAL (CA); MUTHUKUMARAN PACKIRISAMY, PIERREFONDS (CA)

(72) Inventors: MOHAMMADREZA FASIHANIFARD, MONTREAL (CA); MUTHUKUMARAN PACKIRISAMY, PIERREFONDS (CA)

(21) Appl. No.: 18/325,268

(22) Filed: May 30, 2023

Related U.S. Application Data
(60) Provisional application No. 63/346,898, filed on May 29, 2022.

(51) Int. Cl. G02B 26/00

(52) U.S. Cl. CPC G02B 26/002

(57) ABSTRACT

This innovation relates to an integrated multi-band continuous optical filter operating with the mechanical deformation of the guiding waveguides in a controlled manner with a micro-electromechanical device. Notably, the direction of light traveling in multi-channel waveguides changes with the applied mechanical force, causing a shift in the wavelengths reflected back from a concave diffraction grating towards the same channels. The center wavelength of each channel, the filter pass band and the total tuning range of the multi-band filter can be tuned. The presented on-chip reconfigurable optical filter has a wealth of applications in microwave photonics for multi-band communications and multiple optical signal processing for programmable optical networks, such as Dense Wavelength Division Multiplexing (DWDM), tunable laser sources, and switches. Furthermore, this innovation could have potential applications in other fields like measurements, particularly in the manufacture of frequency combs.

### CROSS-REFERENCE TO RELATED APPLICATIONS

This patent application claims the benefit of priority from U.S. Provisional Patent Application 63/346,898 filed May 29, 2022; the entire contents of which are incorporated herein by reference.

### FIELD OF THE INVENTION

This patent application relates to photonic components and more particularly to methods and systems for mechanical tuning of multi-channel photonic components and photonic integrated circuits employing such photonic components.

### BACKGROUND

In response to the enormous demand for data transmission, different technologies like wavelength division multiplexing (WDM), multi-band transmission and programmable networks have undergone significant development to exploit the maximum capacity of the optical networks. In this way, the capacity of the existing optical networks is increased without the need to use new optical fibers. As the number of channels in WDM networks increases, more flexible reconfiguration and higher speeds are required. This has led to the introduction of dynamic networks and wavelength reconfigurability in WDM systems to utilize the maximum capacity of optical networks. The new generation of reconfigurable optical networks employs tunable optical elements and technologies to program the network by dynamically setting up optical paths.

Tunable Optical Filters (TOFs) are a key building block to improve data transmission performance over optical fibers by providing dynamic operation of the system to select between channels with different wavelengths. Further, TOFs with flexibility in the tuning bands allow optimizing the system performance as well as real-time adoption to the environmental changes [1]. Also, TOFs are a critical part of complex WDMs. They either serve to choose between wavelength channels or create tunable sources and receivers. Therefore, tuning the transmission frequency dynamically in a dynamic range can significantly improve the telecommunication system's functionality [2].

The presented device is a new tunable multi-channel filter based on a mechanically reconfigurable asymmetrical slab waveguide that can be integrated with a concave diffraction grating (CDG) and can dynamically control the wavelength in several different bands simultaneously. The presented invention offers comparable advantages over other methods like a smaller size, less losses, and higher throughput capacity, leading to the device's higher overall efficiency. Using an integrated MEMS platform and integrated optics reduces manufacturing costs compared to traditional design approaches. Furthermore, The innovation presented can overcome problems such as the limited number of multiplexing channels for WDM systems and the limited efficiency of tunable multi-band systems. This tuning method could tune multi-band filters with a wide range, low power consumption, fast tuning speed and less heat generation. Manufacturing of integrated multi-band TOFs requires no assembly and simpler fabrication for multi-band filtering that could be a great answer for data center needs.

Finally, the presented innovation could solve the problem of large actuators and high voltage of actuation for no-gap TOFs. Since the no-gap design has a continuously stiff slab waveguide that must bend to tune, it required high force and power to operate. The presented innovation offers a new design for a no-gap tuning mechanism that requires less actuation force for the same tuning range. As a result, the TOF requires a smaller actuator size, less power, and less voltage to operate, resulting in cost and material savings.

To date, several methods for implementing TOFs have been reported. Among the numerous existing methods, the most popular is Photonic Integrated Circuit (PIC) because of its unique advantages such as cost-efficiency, miniaturization, power consumption, and high speed. Typical techniques found in the literature to manufacture TOFs are electro-optics, thermo-optics, acousto-optics, and mechanical actuation using MEMS (FIG. 1 and FIG. 2).

The mentioned tuning methods work based on two principal approaches to creating tunable PICs: phase modulation and amplitude modulation. Phase modulation usually happens by a modification of the refractive index. The electro-optic effect changes the optical properties of photonic media by introducing an external electric field that could affect the refractive index such as the Pockels effect. Other popular techniques to change the refractive index are thermo-optic and acousto-optic effects by introducing thermal radiation or sound waves. Mechanical tuning also can make phase modulation ether with changing the refractive index by applying strain and stress or change the optical patch properties with lengthening and shortening of the waveguide.

Intensity modulation could make tunable PICs through various methods. For example, control on material absorption using electro-optics effects such as the quantum Stark effect. PICs could also be tuned by making a mechanical change in photonic components by moving or deflecting the guiding elements or introducing other photonics mediums to the device. Mechanical movements could change the light intensity by controlling the optical beam deflection angle, introducing an external element, making a mode mismatch, or blocking the optical patch.

The mechanical tuning of photonic devices is a favorable method to control photonic circuits due to its flexibility and fabrication compatibility. In the last few decades, Micro-electromechanical systems (MEMS) have been a successful technology that offers a powerful approach to making tunable PICs. MEMS offers unique advantages like increasing integration at the wafer level, smaller footprint, lower power consumption, faster response time and cost efficiency. Moreover, the MEMS well-developed fabrication technology could be integrated with other existing platforms like silicon photonics [5], [6].

Integrated MEMS platform with PIC directly changes the position of photonics elements by a mechanical movement. This mechanical movement alters the optical signal transmitted through the photonic device in a controlled manner. Mechanically Tunable PICs are reported to suggest an effective method of optical signal manipulation to make robust and low-power platforms for various tunable photonic devices like TOFs, phase shifters, couplers, switches or resonators [7]. FIG. 36 summarizes different tuning concepts using mechanical movements.

After an initial overview of related works, we investigated specific prior works on various designs for the wavelength-tunable photonic systems with mechanical actuation. In 2018, Packirisamy et al. [8] proposed several methods of mechanical tuning for the tunable sources, filters and detectors. In this work, the signal is processed through a single input channel with optical components and mechanical actuators to tune the outputs' optical signal. The presented designs are categorized into three main configurations, i) transmissive Littrow (100A), ii) reflective Littrow(100B), and iii) transmissive Littman-Metcalf configuration (FIG. 3). There are some multi-channel designs presented in transmissive Littrow (100C) configuration with a single input However multi-channel design in reflective Littrow mode (same input and output channels) are not included in the work (FIG. 4).

In the presented invention, unlike [8], the multi-channel tunable platform works in reflective Littrow mode, allowing several inputs and outputs simultaneously. In addition, using reflective Littrow mode helps to have higher optical signal efficiency since input/output waveguides collect signals in the more compact spatial distance located around the focus of the concave diffraction grating.

In 2020 Packirisamy et al. [9] presented several different methods for mechanical actuation of deformable optical beam steering to tune the wavelength of micro-optical systems. Three different regions for optical waveguides and components are defined in this work. The first region in which single optical beams are propagating is fixed. The second region where at least one part of the optical beam is received for further processing and getting back into the first region is also fixed. At least there is a third region between the first and second area that is deformable without physical discontinuities (FIG. 5). Only there is one configuration where region three is not fixed, which is shown in FIG. 6. In this configuration, region three rotates about the center of the CDG, which requires significant force, as the stiffness would be high in the case of rotation about the CDG center. Besides, the multi-channel configuration in this work is in transmissive Littrow or Littman-Metcalf mode, which means that input and output waveguides are not the same and the device has one input with multiple outputs (FIG. 7).

Contrary to [9], In the presented innovation, region three with oppositely propagating optical paths and with more than one optical guiding feature could guide optical signals in the multiple input and/or output channels. In addition, as Littrow mode multi-channel designs increase the stiffness of the deforming regions, regions two and three are free to move or rotate about any fixed point located on regions two or three to reduce mechanical stiffness and increase the optical tuning range.

Finally, in 2020, Menard et al. [10], presented mirror-based microelectromechanical systems and methods. In this work, a rotating mechanical platform, separated from the fixed component by a gap, is mechanically actuated to produce a tunable optical system (FIG. 8). The main difference of the presented innovation from is that the moving parts are separated from the fixed part by an air gap, which causes optical losses and needs additional mechanical platforms to control the optical beam coupling at the gap. However, in the presented innovation, the moving parts for all channels are physically connected to the fixed parts, reducing the gap losses, and simplifying the mechanical platform.

Although new techniques have been developed for improving tunable filter/laser in the past decade, several challenges still need to be addressed. Main difficulties in developing TOFs are power consumption, tuning range, tuning speed, cost efficiency, power efficiency and scalability. In the following, the strength and drawbacks of each primary tuning method are discussed.

To create high-speed TOFs, the electro-optics effect is an excellent choice. However, electro-optics based TOFs are not scalable and have a limited tuning range. The power consumption and heat generation would be a problem in manufacturing TOFs in some electro-optic processes, such as carrier injection. An excellent example of a power consumption issue appears in employing tunable filters in manufacturing tunable lasers. Carrier injection, quantum-confined stark effect (QCSE) methods are popular approaches to change the refractive index for laser tuning. Although the carrier injection method has some advantages like average tuning range and high switching speed, it consumes power continuously and generates heat that makes the laser unstable. There are other designs like QCSE without heating and instability problems, but they give very narrow bandwidth[6], [12].

The Thermo-optics effect is the right choice to achieve a large tuning range for TOFs. It could be implemented on different photonics elements and resonators such as micro-ring-resonators, Mach-Zehnder interferometers, and arrayed waveguide gratings (AWGs). The significant limitation of the thermo-optic effect is tuning speed and power consumption. Another weakness of this method is the reliability of the tunable filter since the latch mechanisms are not possible with this method. In the case of tunable lasers application, the issue of using temperature to control the laser output is that temperature change makes the laser unstable. Also, these tuning approaches have limited uses because of their limited output power [13].

The acousto-optic effect is also a powerful tool to manipulate optical rays. It is relatively fast (less than 10 μs) and also offers a wide tuning range (>100 nm). Another advantage of this method is the multi-channel selectivity. However, the size of the tunable acousto-optical components is relatively large and has high crosstalk between the channels.

The mechanical tuning method is the other powerful method for making TOFs. Traditional beam steering methods were bulky and slow. In the last few decades, Micro-electromechanical systems (MEMS) have been a successful technology that offers a powerful approach to making tunable devices. MEMS offers unique advantages like increasing integration at the wafer level, smaller footprint, lower power consumption, faster response time and cost-efficiency. Moreover, the well-developed MEMS fabrication technology could be integrated with other existing platforms like silicon photonics. However, this method has some drawbacks, like optical losses because of discontinuity due to moving parts. In the case of using continuous waveguides to avoid gap losses, high actuation forces and large actuators are a challenge. Also, current MEMS TOFs usually offer a single band tunable filter on a device and are not scalable [5].

The presented innovation not only benefits from the advantages of the MEMS tuning mechanisms but also addresses the main challenges of MEMS tunable TOFs. The presented innovation provides an on-chip integrated method to select between different wavelengths. Continuous asymmetrical slab waveguide with multiple inputs/outputs helps create multi-band TOFs that tune multiple channels simultaneously with a single diffractive optical element. Also, a continuous deformable waveguide avoids the optical losses due to embedded gaps for element movement. Using a combination of input or outputs with different bands enables the present device to operate in a dynamic wavelength range with an extensive tuning range.

The new design for the no-gap (continuous waveguides) mechanical TOFs allows the device to tune the wavelength of the output with less mechanical force and consequently less power and voltage. Notably, Changing the fixed positions and point load force on the free-standing asymmetrical waveguide results in a less rigid structure that requires less force to deform and tune the output waveguides.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to photonic components and more particularly to methods and systems for mechanical tuning of multi-channel photonic components and photonic integrated circuits employing such photonic components.

In accordance with an embodiment of the invention there is provided an optical device comprising:
a first region in which multiple optical beams are propagating.
a second region (Which could be either fixed or movable), where at least one part of the optical beam is received for further processing back into the first region; and
at least one third region between the first region and second region which is deformable without physical discontinuities with the first region and second region supporting oppositely propagating optical paths with more than one optical guiding features; wherein
the deformation of the third or second region results in the optical beam, received back in the third region having at least one of a different orientation and a different position than it initially had, after processing in the second region.

The present invention consists of an optical and mechanical device in which the position and angle of multiple optical beams can be controlled simultaneously. This change in the angle and position of optical beams could be utilized to make desired change in the optical signals passing through the device. We are specifically interested in the aspects of multi-band filtering as they serve to make optical network elements more flexible.

Using deformable multi-channels (inputs and outputs) together to filter several channels at once and create a scalable multi-band TOF is an originality to create a tunable multi-band filter on the chip with continuous medium. Another originality lies in the TOF structure creating a less rigid structure that needs smaller force and more miniature actuators with lower power consumption and voltage to move and tune the channel wavelengths. Finally, combining different inputs and/or outputs results in a tunable TOF or diode laser with a flexible frequency band.

The invention could widely be used in programmable optical networks and data centers by providing active optical components like optical switches, multi-band tunable filters, multi-channel tunable lasers and active WDMs. In addition, the invention has application in any device that needs a tunable source with an external or on-chip integrated source like coherent optical tomography or hyperspectral imaging for handheld devices. Finally, the invention could be beneficial for making miniaturized measurements devices like an On-chip integrated spectrometer and frequency combs for ultra-short pulse lasers.

Other aspects and features of the present invention will become apparent to those ordinarily skilled in the art upon review of the following description of specific embodiments of the invention in conjunction with the accompanying figures.

### BRIEF DESCRIPTION OF DRAWINGS

Embodiments of the present invention will now be described, by way of example only, with reference to the attached Figures, wherein:

FIG. 1 depicts an acousto-optic tunable filter according to the prior art;

FIG. 2 depicts a Tunable Optical Filter (TOF) with fiber Bragg grating and thermally tunable platform according to the prior art;

FIG. 3 depicts existing methods of mechanical tuning for the tunable sources;

FIG. 4 depicts existing methods of mechanical tuning for multi-channel designs presented in transmissive Littrow mode;

FIG. 5 depicts the existing method for mechanical actuation of deformable optical beam steering to tune the wavelength of micro-optical systems;

FIG. 6 depicts existing methods for mechanical actuation of deformable optical beam steering to tune the wavelength of micro-optical systems with the rotational platform;

FIG. 7 depicts existing methods for mechanical actuation of a multi-channel deformable optical beam steering to tune the wavelength of micro-optical systems;

FIG. 8 depicts existing mirror-based microelectromechanical systems and methods;

FIG. 9 depicts a schematic of the invented Multi-Channel TOF working principle;

FIG. 10 depicts a schematic of the deformed Multi-Channel TOF;

FIG. 11 depicts the reflected different wavelengths around the central input waveguide;

FIG. 12 depicts both side actuation of the Multi-Channel TOF;

FIG. 13 shows that Multi-Channel tunable filter channel spacing could be controlled by adjusting the spatial distance of output channels from the input channel as a design parameter;

FIG. 14 depicts an array waveguide grating (AWG) with mirrors at the end of the waveguides to replace a concave diffraction grating (CDG);

FIG. 15 depicts the TOF configuration for a multi-channel tunable optical filter;

FIG. 16 depicts the asymmetric slab waveguide geometry of the TOF;

FIG. 17 depicts a three-Channel filter with 9 nm channel spacing at zero actuation;

FIG. 18 depicts a three-Channel filter with 9 nm channel spacing at −5 μm actuation; The channel spacing is still 9 nm at 5 μm deformation;

FIG. 19 depicts a three-Channel filter with 9 nm channel spacing at +5 μm actuation; The channel spacing is still 9 nm at 5 μm deformation;

FIG. 20 depicts the linear relationship between the change in wavelength and waveguide deformation;

FIG. 21 demonstrates three-channels outputs for a tuning range of 10 μm (5 μm actuation at each side) and a resolution of 1 μm;

FIG. 22 shows the increase in the overall tuning range of the multi-channel tunable filter; In this design, each channel has a 30 nm tuning range, and each channel adds up a 9 nm tuning range to the mail middle channel due to the 9 nm channel spacing of TOF;

FIG. 23 depicts the TOF configuration for a multi-band tunable optical filter;

FIG. 24 depicts the central channel output power of a multi-band TOF with two reflectors;

FIG. 25 depicts a tunable diode laser configuration with one SOA chip;

FIG. 26 depicts the configuration of a tunable diode laser with SOA for each channel;

FIG. 27 depicts the Littrow configuration for all channels when using multiple SOAs to design a tunable laser;

FIG. 28 depicts the Rowland Geometry;

FIG. 29 depicts the working principle of the first mechanical configuration;

FIG. 30 depicts the working principle of the second mechanical configuration;

FIG. 31 depicts the working principle of the third mechanical configuration;

FIG. 32 depicts the Slab waveguide stiffness for different configurations;

FIG. 33 depicts the effective change in the angle of incident light to the grating;

FIG. 34 depicts the tuneability comparison of presented designs for 0-7.5 mN force;

FIG. 35 depicts the output power of the central channel of the first (a), second (b), and third (c) configurations where the device were simulated for five different actuations with amounts of −7.5 mN, −3.75 mN, 0 mN, 3.75 mN, and 7.5 mN, each marked with A1 to A5, respectively;

FIG. 36 depicts MEMS Tuning Concepts for Photonic Integrated Circuits;

FIG. 37 depicts TOF dimensions of the simulated designs;

FIG. 38 depicts a multi-band TOF configuration according to an embodiment of the invention with multi-band filtering with the center channel input/output; and

FIG. 39 depicts a tunability comparison of the three exemplary mechanical configurations presented according to embodiments of the invention.

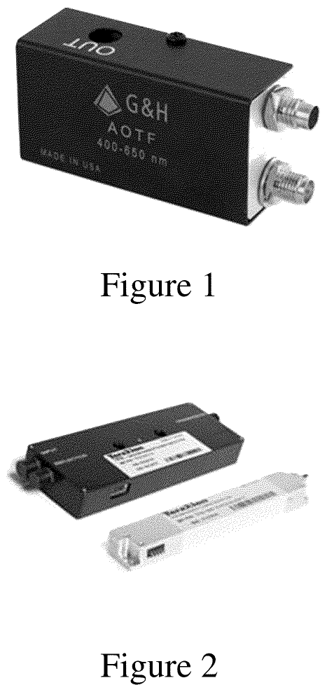

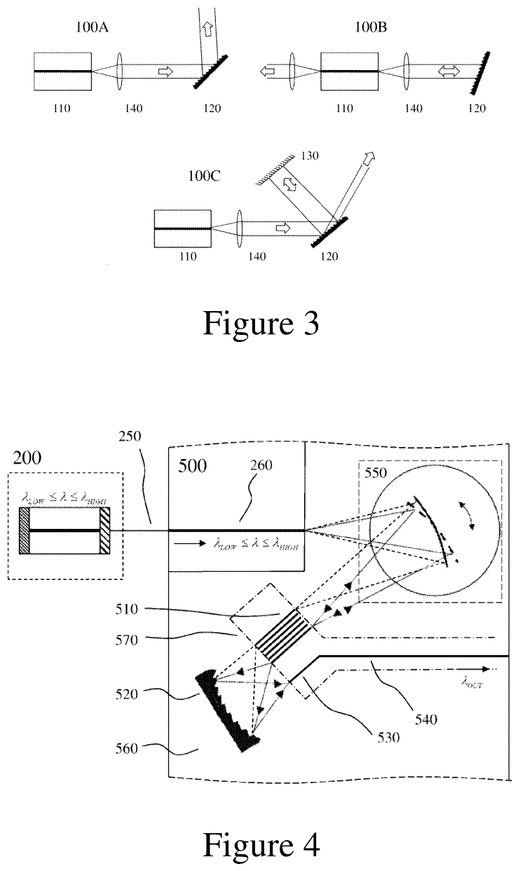

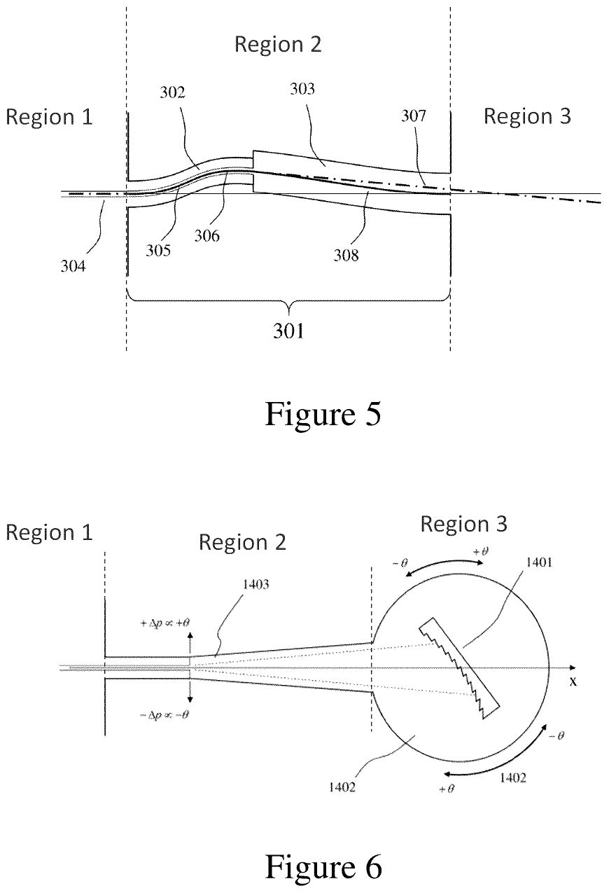

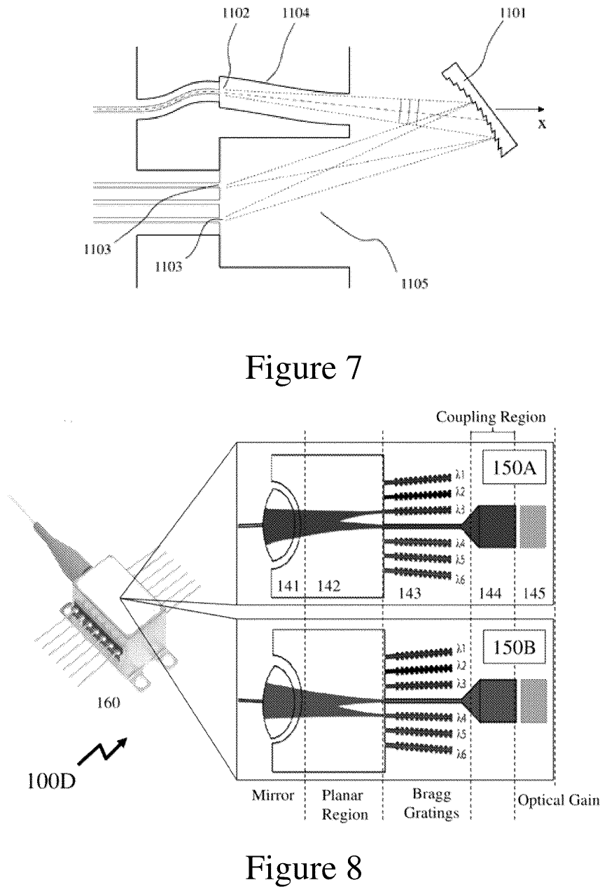

### DETAILED DESCRIPTION

The present invention is directed to photonic components and more particularly to methods and systems for mechanical tuning of multi-channel photonic components and photonic integrated circuits employing such photonic components.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “ceramic” as used herein may refer to, but is not limited to, an inorganic, nonmetallic solid material comprising metal, non-metal or metalloid atoms primarily held in ionic and covalent bonds. Such ceramics may be crystalline materials such as oxide, nitride or carbide materials, elements such as carbon or silicon, and non-crystalline. Exemplary ceramics may include high temperature ceramics or high temperature co-fired ceramics such as alumina (Al2O3), zirconia (ZrO2), and aluminum nitride (AlN) or a low temperature cofired ceramic (LTCC). A LTCC may be formed from a glass—ceramic combination.

A “metal” or “alloy” as used herein may refer to, but is not limited to, a material having good electrical and thermal conductivity. Metals are generally malleable, fusible, and ductile. Metals as used herein may refer to elements such as gold, silver, copper, aluminum, iron, etc. whilst an alloy as used herein refers to a combination of metals such as bronze, stainless steel, steel etc.

A “polymer” as used herein may refer to, but is not limited to, is a large molecule, or macromolecule, composed of many repeated subunits. Such polymers may be natural and synthetic and typically created via polymerization of multiple monomers. Polymers through their large molecular mass may provide unique physical properties, including toughness, viscoelasticity, and a tendency to form glasses and semi-crystalline structures rather than crystals.

A “glass” as used herein may refer to, but is not limited to, a non-crystalline amorphous solid. A glass may be fused quartz, silica, a soda-lime glass, a borosilicate glass, a lead glass, an aluminosilicate glass for example. A glass may include other inorganic and organic materials including metals, aluminates, phosphates, borates, chalcogenides, fluorides, germanates (glasses based on GeO2), tellurites (glasses based on TeO2), antimonates (glasses based on Sb2O3), arsenates (glasses based on As2O3), titanates (glasses based on TiO2), tantalates (glasses based on Ta2O5), nitrates, carbonates, plastics, and an acrylic.

Embodiments of the invention may be implemented within one or more semiconductor materials (semiconductors), grown for example through LPE, MOCVD or OMVPE. The one or more semiconductors may include, but are not limited to, group III-V semiconductors, II-VI semiconductors, group IV semiconductors, and group IV-V-VI semiconductors. Examples of group III-V semiconductors may include AlP, AlN, AlGaSb, AlGaAs, AlGaInP, AlGaN, AlGaP, GaSb, GaAsP, GaAs, GaN, GaP, InAlAs, InAlP, InSb, InGaSb, InGaN, GaInAlAs, GainAIN, GaInAsN, GaInAsP, GaInAs, GaInP, InN, InP, InAs, InAsSb, InGaAsP and AlInN. Examples of group II-VI semiconductors may include ZnSe, HgCdTe, ZnO, ZnS, and CdO. Examples of group IV Semiconductors may include Si, Ge, and strained silicon. A group IV-V-VI semiconductor may be GeSbTe.

A “two-dimensional” waveguide, also referred to as a 2D waveguide, slab waveguide or a planar waveguide, as used herein may refer to, but is not limited to, an optical waveguide supporting propagation of optical signals within a predetermined wavelength range which does not guide the optical signals laterally relative to the propagation direction of the optical signals.

A “three-dimensional” waveguide, also referred to as a 3D waveguide, a channel waveguide, or simply waveguide as used herein may refer to, but is not limited to, an optical waveguide supporting propagation of optical signals within a predetermined wavelength range which guides the optical signals laterally relative to the propagation direction of the optical signals.

A “photonic integrated circuit” (PIC) as used herein may refer to, but is not limited to, the monolithic integration of multiple integrated optics devices into a circuit formed upon a common substrate providing an optical routing and processing functionality. The PIC is fabricated using processing techniques at a wafer level, e.g. CMOS manufacturing flows, MEMS processing flows, etc.

Within the following embodiments of the invention reference to a particular waveguide and MEMS technology, e.g. silicon-on-insulator optical waveguides on silicon substrates with silicon MEMS actuators, may be made. However, it would be evident that the underlying design concepts and principles may be applied to other waveguide technologies on silicon substrates with silicon MEMS actuators. It would be also that the underlying design concepts and principles may be applied to other waveguide technologies on other substrates supporting MEMS actuators. For example, such substrates may include, but not be limited to, GaAs and InP for semiconductor platforms allowing monolithic integration of embodiments of the invention with active photonic elements (e.g. laser diodes, photodetectors, semiconductor and optical amplifiers) and passive photonic elements rather than hybrid integration of active photonic elements with silicon and other passive platforms.

Embodiments of the invention may also be implemented using optical waveguides upon polymeric substrates supporting MEMS elements, metal substrates supporting MEMS elements and ceramic substrates supporting MEMS elements. The optical waveguides in each instance may be formed from another material system or within the same material system as the substrate, e.g. polymer optical waveguides on polymeric substrate, hollow infrared metallic waveguides on metallic substrates and ceramic waveguides on ceramic substrates.

Embodiments of the invention may also be implemented using optical waveguides and MEMS formed upon substrates not supporting MEMS elements such as glass substrates. Embodiments of the invention may also be implemented using MEMS formed upon substrates not supporting MEMS elements such as glass substrates but the substrates do support optical waveguides.

Embodiments of the invention employing optical waveguides may employ a waveguide core embedded within upper and lower claddings, a so-called buried waveguide, an air clad waveguide (i.e. a core with lower cladding and air elsewhere), a rib waveguide, a diffused waveguide, a ridge or wire waveguide, a strip-loaded waveguide, a slot waveguide, an anti-resonant reflecting optical waveguide (ARROW waveguide), a photonic crystal waveguide, a suspended waveguide, an alternating layer stack geometry, a sub-wavelength grating (SWG) waveguides or an augmented waveguide (e.g. Si—SiO₂—Polymer). Embodiments of the invention may employ a step index waveguide, a graded index waveguide or a hybrid index waveguide (such as combining inverse-step index and graded index).

Multi-Channel TOF Working Principle

The present invention consists of an optical and mechanical device in which the position and angle of multiple optical beams can be controlled simultaneously. This change in the angle and position of optical beams could be utilized to make desired change in the optical signals passing through the device.

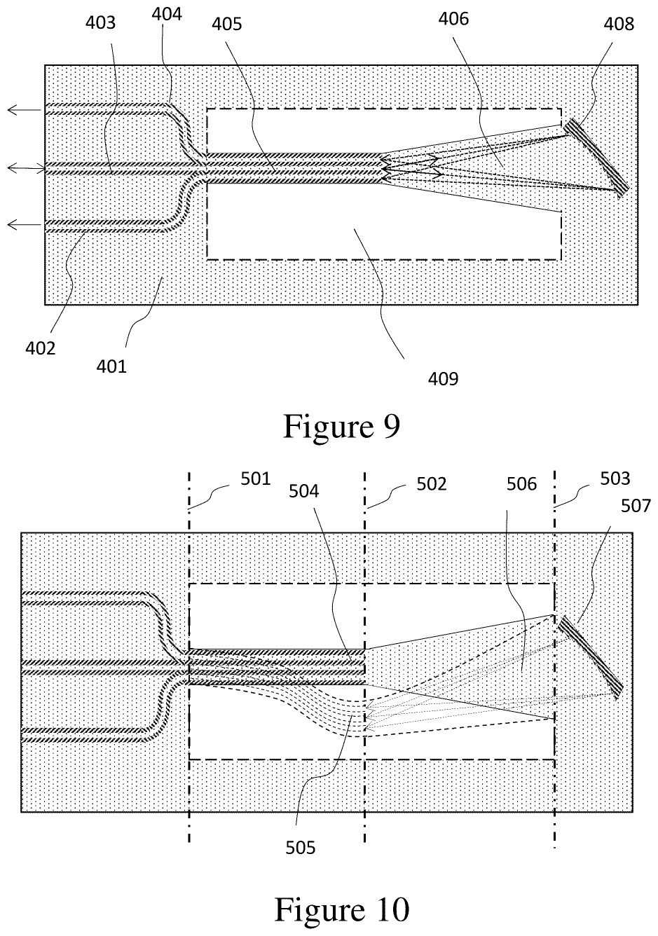

In FIG. 9, region 401 is a silicon-on-insulator (SOI) platform as a substrate for the optical waveguides. The photonic parts in areas 402 to 408 are made of silicon (Si) core covered by a silicon dioxide (SiO₂) cladding deposited on the SOI platform that allows the manufacture of a single mode waveguide with low propagation loss.

Area 401 is etched on the back in areas in which the photonic part would like to move freely. As illustrated in FIG. 9, the device consists of three fixed access waveguides 402, 403 and 404. Any of these three access waveguides could function as both input and output channels of the device. The number of channels for the TOF could also be varied depending on the application. However, there is always a trade-off between the number of channels and channel power efficiency. The areas 405 and 406 are movable parts that are released by the backside etching of the silicon handle of the SOI substrate. The area 409 that is not patterned in the backside etching is entirely removed. Finally, region 408 is a concave diffraction grating (CDG) that functions either as a dispersive optical element or as a mirror.

The input light could pass through any of the three access waveguides. Then the input light diverges in the trapezoidal slab waveguide, later referred to as the free space area (LFSR) and illuminates the CDG. The CDG focuses the diffracted light at different angles depending on the wavelength of the corresponding output waveguide.

The asymmetrical slab waveguide (parts 405 connected to 406) is bent using a MEMS actuator connected to the junction of access waveguides and the LFSR. A high force electrostatic comb drive could provide enough force for the slab waveguide actuation [3]. In designs with more channel numbers, the asymmetrical slab waveguide can be stiffer due to the wider mechanical beam in the straight part of the slab waveguide. Designs two and three are presented in the following to address this issue.

As illustrated in FIG. 10, The movement caused by the actuator results in either changing the incident angle of light on the CDG or shifting the initial position of the input and output waveguides. Consequently, the mechanical actuation ultimately leads to a wavelength shift in the output waveguides.

As shown in FIG. 10, the asymmetrical waveguide is bent by applying a force to region 502. As a result, the areas 505 and 506 deform. The light passing through region 504 is guided laterally in parallel channels. However, when the light beam enters region 506 it is no longer guided laterally. Since the areas 501 and 507 are fixed during the actuation, the wavefront propagating in area 506 reaches the CDG at an angle with respect to the case of no actuation. Therefore, reflected light from CDG is focused on different outputs depending on the wavelength.

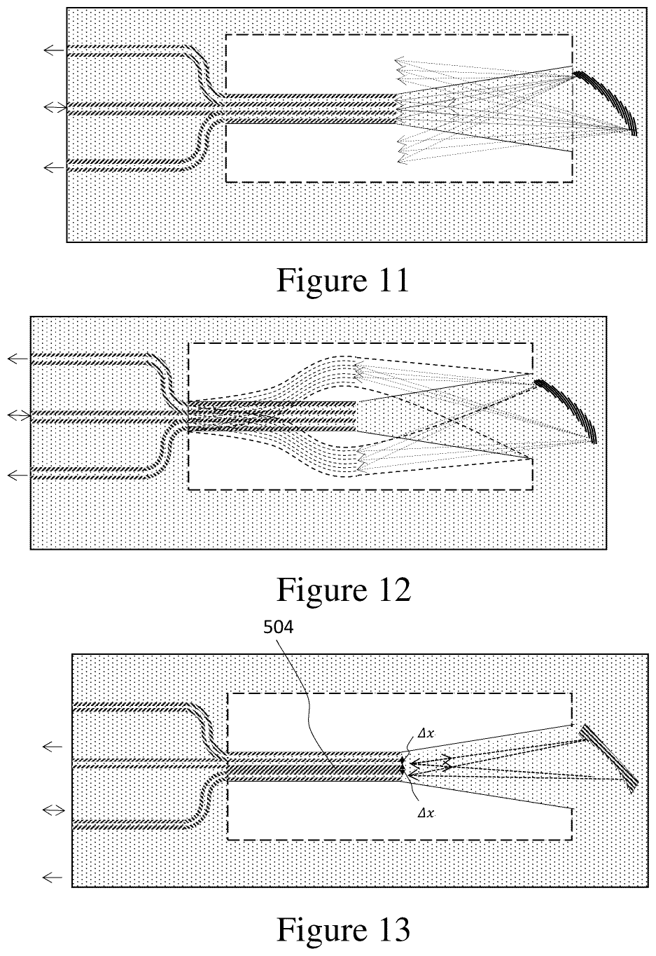

The CDG is designed to reflect different wavelengths around the central input waveguide (FIG. 11). Therefore, actuation at both sides could allow the TOF to collect a broader range of wavelengths (FIG. 12). Using an actuator on both sides of the free-standing waveguide could increase the tuning range with less mechanical force and higher optical efficiency.

Depending on the spatial position of the output waveguide, different wavelengths could be collected at the end of the LSFR. Therefore, changing the separation of the output waveguide from the input waveguide determines the tunable filter bands (FIG. 13). In this way, the spatial channel separation in the straight waveguide could be viewed as the primary design parameter for controlling the tunable filter bands.

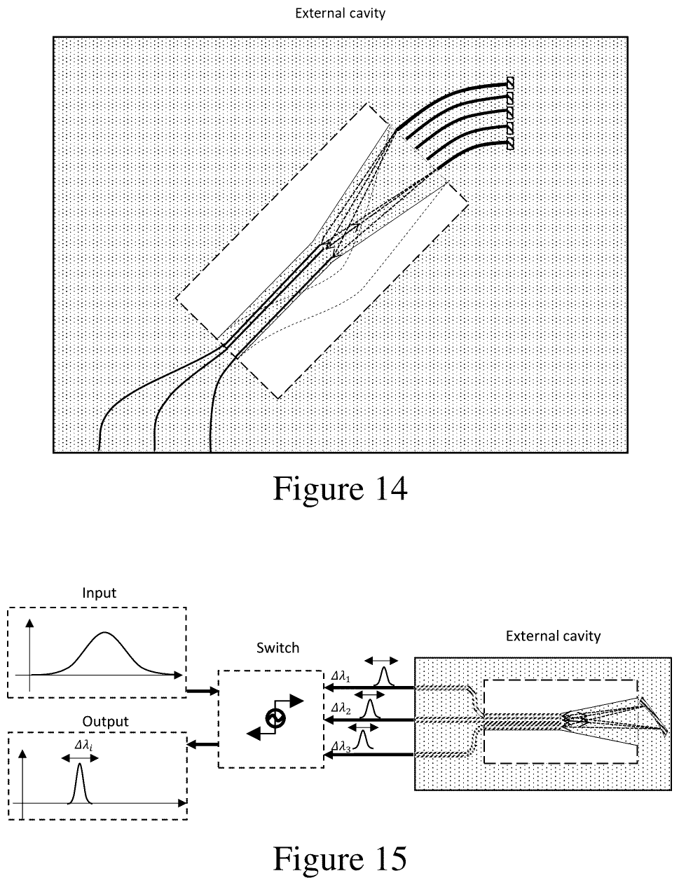

The TOF presented here could also be used with other diffractive optical elements to separate and reflect different wavelengths. For example, an arrayed waveguide grating with reflective coatings on the arrayed waveguides could act as a grating and mirror to separate different wavelength of the incident light and focus back the light to the outputs (FIG. 14). The position of the AWG waveguides at the end of the free propagation region and the length of each AWG waveguide determines the diffractive element properties to design the channel wavelengths.

Tunable Optical Filter Configuration (Single-Band)

The presented TOF can have different configurations depending on the application. The first is a multi-channel TOF with a single frequency band (FIG. 15). In this configuration, a broadband signal would be an input to any channel, and each channel captures a single band of frequencies whose center frequency could be tuned. In the case where active devices are made for switching between different frequency bands, an optical switch is selected between input and output channels to establish a desired center wavelength of the output frequency band and then tune that center frequency by the TOF.

Simulations

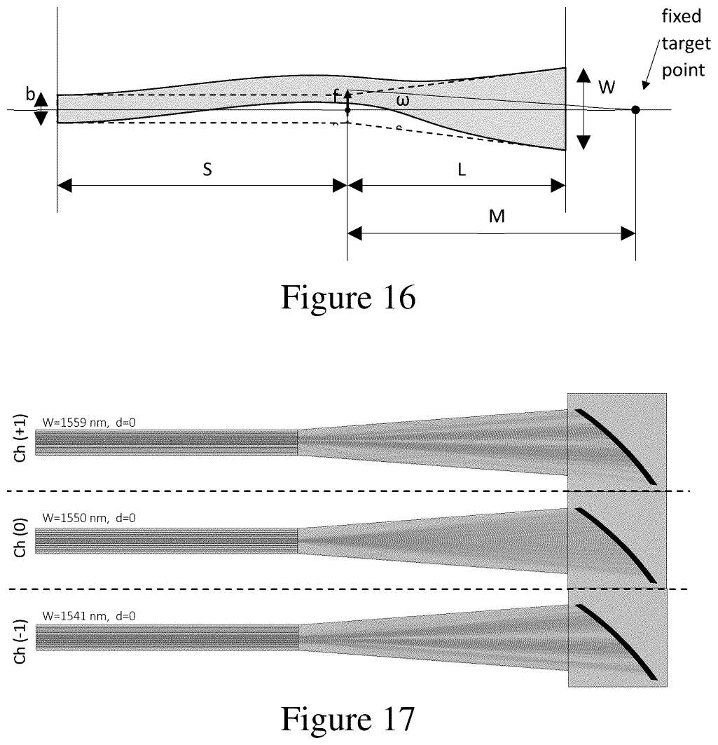

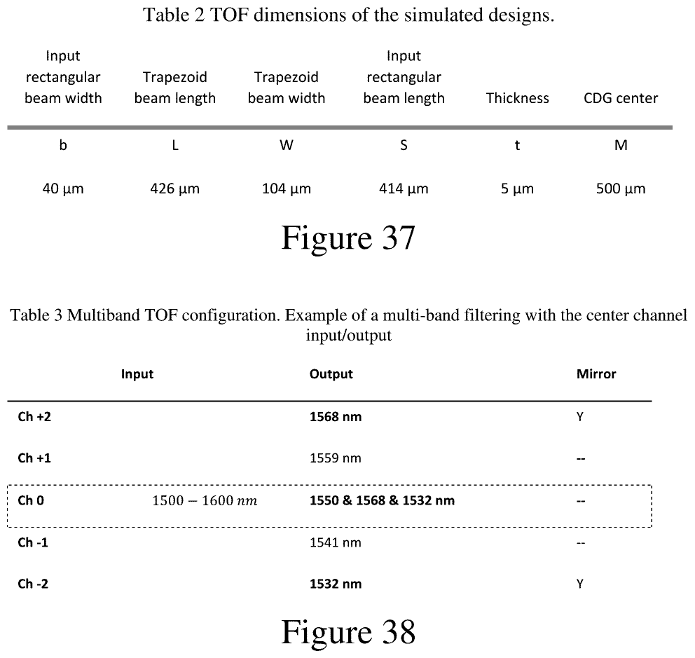

As an example, a multi-band tunable filter is modeled with elliptical Bragg mirror concave diffraction grating. Both mechanical and optical part of the design are simulated with the finite element method using COMSOL Multiphysics and the result is validated with the FDTD simulation method. The geometry of the asymmetrical slab waveguide in the simulated model is described in FIG. 16 and FIG. 37.

A silicon core enclosed in silica cladding is used to design and simulate a low propagation loss waveguide on the SOI platform. The designed tunable filter is simulated for the continuous actuation of −5 μm to 5 μm (at the center of the waveguide), which needs 17 mN force.

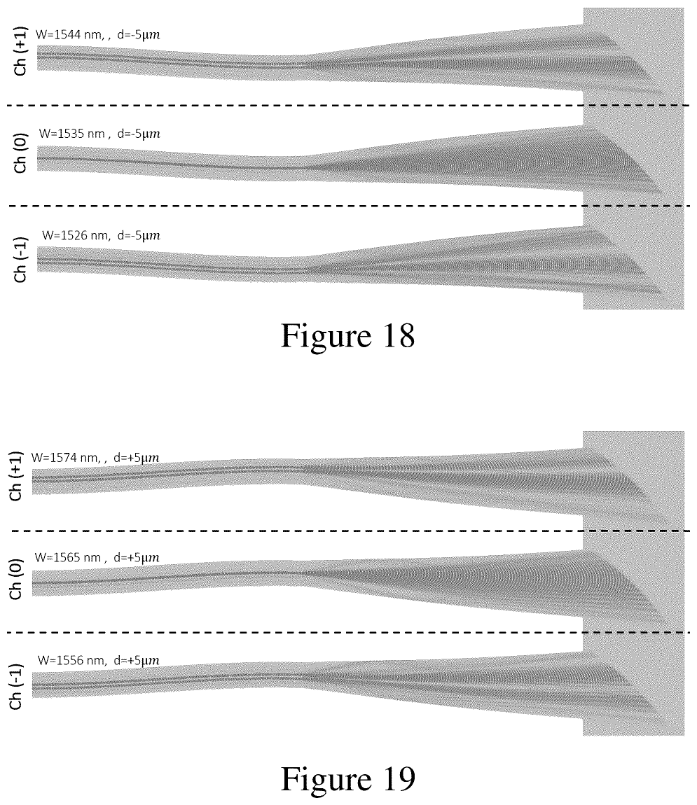

FIG. 17 Three-Channel filter with 9 nm channel spacing at zero actuation. Also, FIG. 18 and FIG. 19 show the TOF while the straight waveguide and trapezoidal slab waveguide junction is actuated by −5 μm and +5 μm, respectively. As shown in FIG. 17, the Ch-0 will collect a wavelength of 1550 nm at zero actuation. By moving the waveguide in the direction of Ch-1, the coupled wavelength decreases. Ultimately the 5 μm actuation leads to a 15 nm change in the Ch-0 wavelength (FIG. 18). According to the spatial separation of channels, other channels have a different wavelength at the zero actuation.

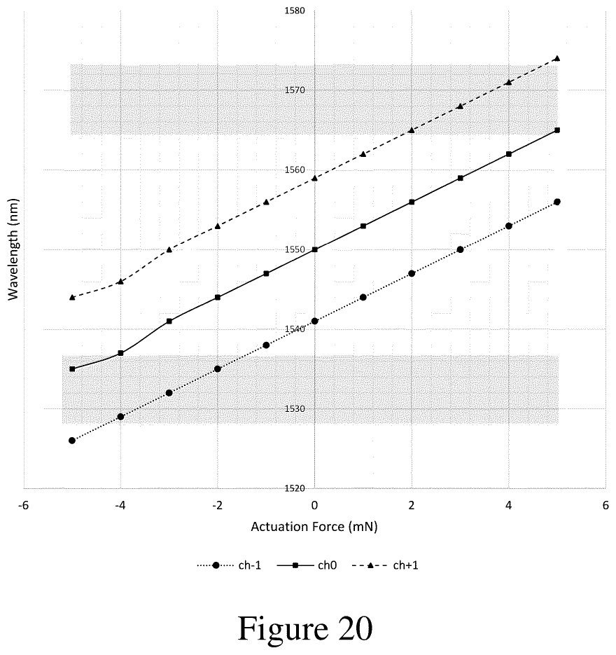

According to Multiphysics simulations of the device (i.e., solid-state mechanics and wave optics physics), the deformation of the junction of the LFPR and the access waveguide has a linear relationship with wavelength variation (FIG. 20).

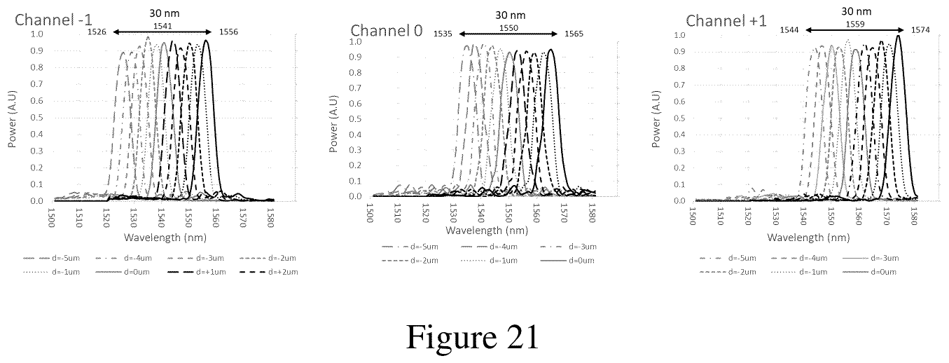

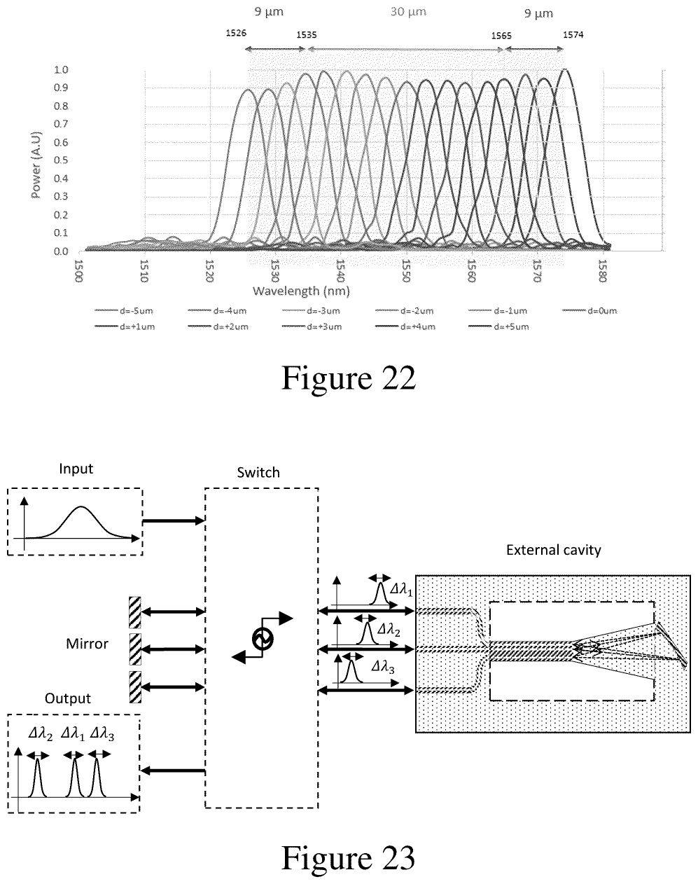

This device could be tuned over a 30 nm range with double-sided actuation for each channel. FIG. 21 demonstrates three-channels outputs for tuning range of 10 μm (5 μm actuation at each side) and resolution of 1 μm. In this simulation, the input channel is considered to be the middle channel (Ch 0). The center wavelength of the tuning range of each channel has a shift equal to the filter channel spacing, which for this design is 9 nm. For this reason, the TOF offers a wide tuning range by switching between all outputs (FIG. 15). In the presented design, the two side-channels (Ch −1 and Ch +1) add an 18 nm tuning range (twice the TOF channel spacing) to the filter bandwidth (FIG. 22).

Tunable Optical Filter Configuration (Multiple-Band)

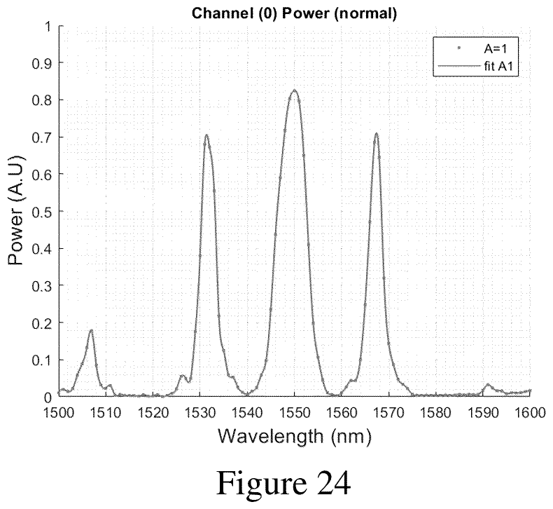

The second configuration of the TOF would be a TOF with multi-frequency band output. In this configuration, a combination of different channels would be selected to make a multi-band tunable filter (FIG. 23). In this regard, a multiplexer is needed to combine the frequency of different channels. In the presented innovation, the TOF itself is used as a multiplexer to combine different channel frequencies. As illustrated in FIG. 23, embedding a reflector at the end of each channel reflects the channel passband frequency back to the input, which is the output. Therefore, by placing a reflector on the desired channel, different combinations of passbands could be made. In FIG. 38, one example of multi-band TOF is presented. In this example, a five-channel TOF is simulated that the middle channel is considered input and output. Reflectors are embedded at the end of the channel (+2) and (−2) to add these two channels' frequency bands to the output. As the FIG. 24 is shown, a multi-band output of channel (0) is a combination of the channel (+2), (0), and (−2).

Because reflected wavelengths from channels with a reflector travel twice through the waveguides and LFSP, they experience more losses than the center channel. These losses stem from longer travel distances in multimode waveguides, DBR losses, and coupling losses from FLSR to the waveguides. These losses are advantageous in the multi-band tunable laser configuration to avoid laser instability.

Tunable Laser Configurations

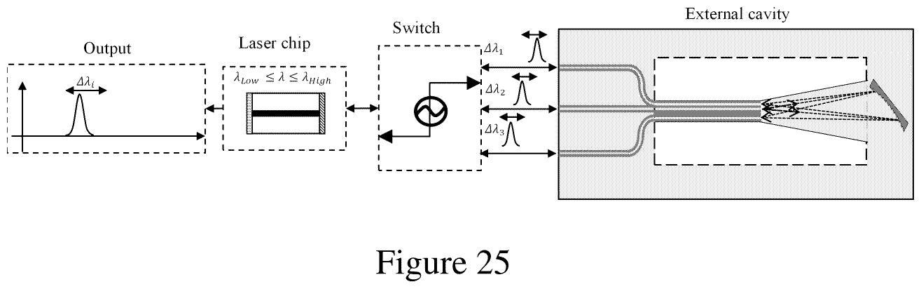

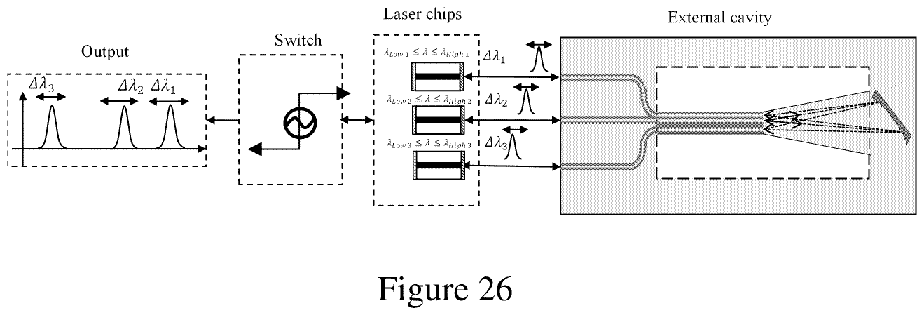

The presented multi-channel tunable platform could also be used as an external cavity tunable diode laser by combining the TOF as an external cavity with a semiconductor optical amplifier (SOA). The SOA could use in two different designs. First, the SOI and TOF form a single cavity, with the output of the multi-channel TOF connected to the SOA with an optical switch to select the tunable laser bandwidth (FIG. 25). In this design, the tunable laser has one single lasing wavelength according to the TOF wavelength and band. In the second multi-channel tunable laser design, each channel has a separate SOA to make a complex cavity (FIG. 26). Indeed each channel forms a cavity with its SOA and the Bragg mirror of the external cavity. Each channel passes a single wavelength, and this wavelength could be tuned according to the mechanical actuation of the external cavity.

Because of SOA's reflecting parts, the external cavity would be complex. The light beam that comes into each channel reflects in all channels depending on the wavelength. This way, other channels can pick up a small amount of power from other wavelengths. However, this small power of irrelevant wavelength would not be amplified because the CDG does not reflect it back onto the same channel. In fact, each channel has a unique wavelength that could be reflected back onto the same channel (hereinafter called the Littrow wavelength), and that wavelength would be the lasing wavelength of that channel.

Another point worth pointing out is cavities with two or more SOAs that form because of the reflection of adjacent channels. All the reflected wavelengths rather than the Littrow wavelength are less powerful due to the additional losses they experience while traveling throw the adjacent channel and reflecting back. Therefore, as illustrated in FIG. 24, reflected wavelengths from adjacent channels would not be the lasing wavelength.

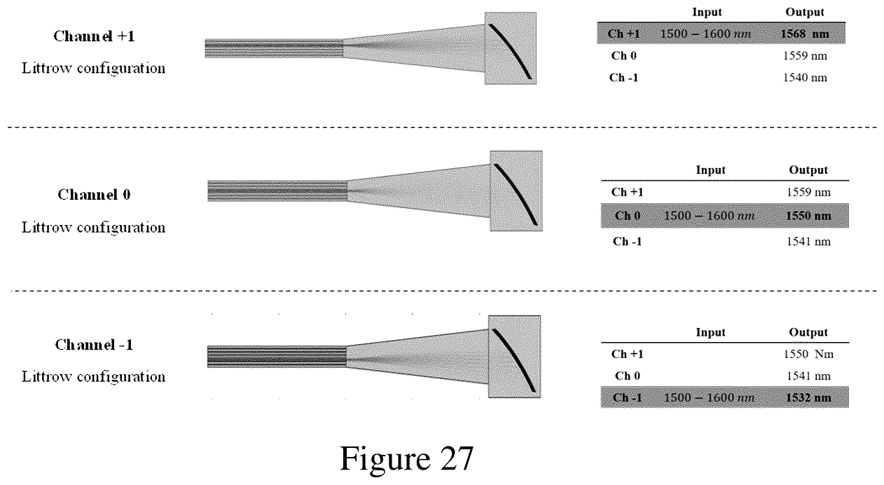

FIG. 27 illustrate details of Littrow mode for every channel. The channel spacing in the simulated design is 9 nm. However, if the input channel is switched from the center channel to the side channels, the Littrow wavelength for each channel shows a change of twice the channel spacing. Thus, for the presented design, the Littrow wavelength of channel 0 is 1550, the Littrow wavelength of channel +1 is 1568 nm, and the Littrow wavelength for channel −1 is 1532 nm. In addition to tunable laser application, the configuration with several SOA could be an excellent choice for making multi-channel ultrashort pulse lasers. This design could produce a pulsed laser with multiple wavelengths at the same time, all of which could be tuned.

New Designs for Multi-Channel TOFs with Reduced Actuation Force

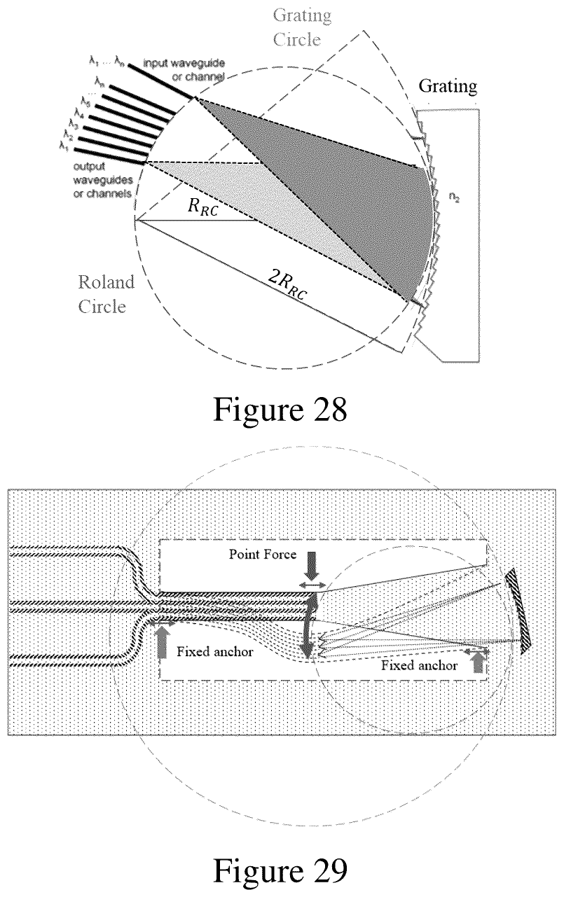

TOF with more channels could have a wider slab waveguide which is stiffer and harder to actuate. Therefore, new configurations are presented to increase the tuning range for the same mechanical force to avoid large actuators and high power and voltage for the actuation. The optical filtering in the presented devices is based on CDG and Rowland geometry. According to the Rowland geometry, The device Input and output waveguides placed on the Rowland circle radius (R_RC) and diffraction grating with a 2R_RC radius is tangent to the Rowland circle. The input light diverges in the laterally free space region (LFSR). After reflecting from elliptical Bragg grating, the light diffracts and focuses back into one of the outputs based on the input wavelength (FIG. 28).

Understanding Rowland geometry provides three main methods of modifying device geometry for wavelength tunability, which are described below.

First Configuration

The first configuration consists of three regions. The first region in which multiple optical beams are propagating is fixed. The second region where at least one part of the optical beam is received for further processing and getting back into the first region is also fixed. At least there is a third region between the first and second area that is deformable without physical discontinuities and with oppositely propagating optical paths and with more than one optical guiding feature. The deformation of the third region results in the optical beam received back in the third region having at least one of a different orientation and a different position than it initially had after processing in the second region.

On the basis of the Rowland geometry, the grating in region two is placed on the grating circle (r=2 R_RC) and the waveguide entrance in region three is located on the Rowland circle (r=R_RC). The waveguide entrances move along the Rowland circle using a point force provided by an integrated MEMS actuator to perform mechanical tuning. Therefore, changing the entry position and angle of the waveguide with respect to the fixed CDG enables the device to choose between different wavelengths.

Second Configuration

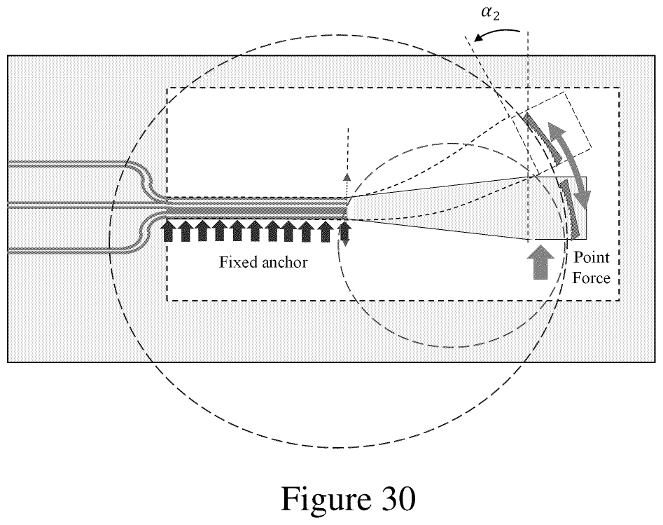

In the second design, region one is fixed and region two, where the light process, is movable. Region three, which connects region one with region two, is flexible or partially flexible like design one. Based on Rowland geometry, the grating moves on the grating circle to change the grating angle with respect to the waveguide entrances (FIG. 30). Therefore, mechanical actuation changes the wavelengths reflected in the waveguide entrances by changing the grating position on the Rowland circle. The primary change in grating angle to waveguide entry angle is owing to the bending of the trapezoidal portion of the slab waveguide during actuation.

Third Configuration

The third configuration is the same as the second configuration, but the fixed part of straight waveguides is only fixed at one single point. This means that the waveguide entrance can rotate around a single fixed point.

Rotation of the entrance waveguides could reduce the tunability range of the third design because the relative change of the waveguide entrance angle to the grating angle is defined by Equation (1).

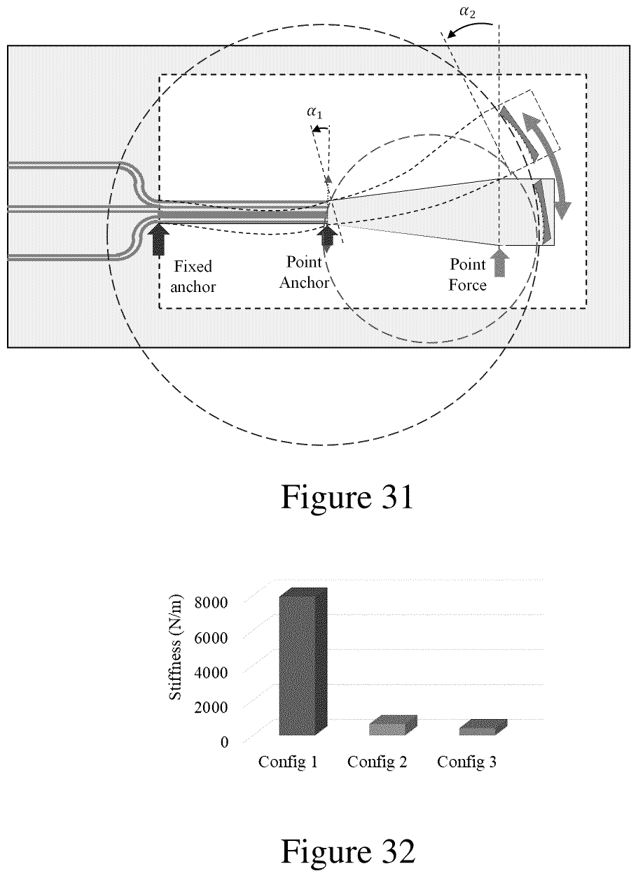

δα=α₂−α₁ (1)

Where α₂ is grating rotation, α₁ is waveguide entrance rotation and δα is the relative rotation of the entrance waveguides to the grating (FIG. 31). Therefore when the waveguide entrances rotate with the grating, the relative change of the waveguide entrance angle to the grating angle reduces. But since the stiffness of the slab waveguide in the third configuration reduces, the device's overall tunability would be more than the second configuration.

Comparison of Configurations

The first means of comparison is the difference between the mechanical properties of the configurations presented. In the first configuration, a point force tends to bend an anchored-anchored asymmetric beam; however, in the second and third designs the point force will bend an anchored-free beam that is less stiff than the first configuration. FIG. 32 illustrates the stiffness comparison of all designs. The second and third configurations significantly decrease the slab waveguide stiffness. The third configuration is even less rigid than the second due to its greater degree of freedom. Note that the stiffness of mechanically tunable devices could play a significant role in the manufacture of MEMS actuators and the complexity of integration. Less rigid waveguides would require less mechanical force to move, which has the benefits of making smaller devices and consuming less power. In addition, the requirement for a lower mechanical force enables the choice of a more robust and faster actuator for integration into the photonic component.

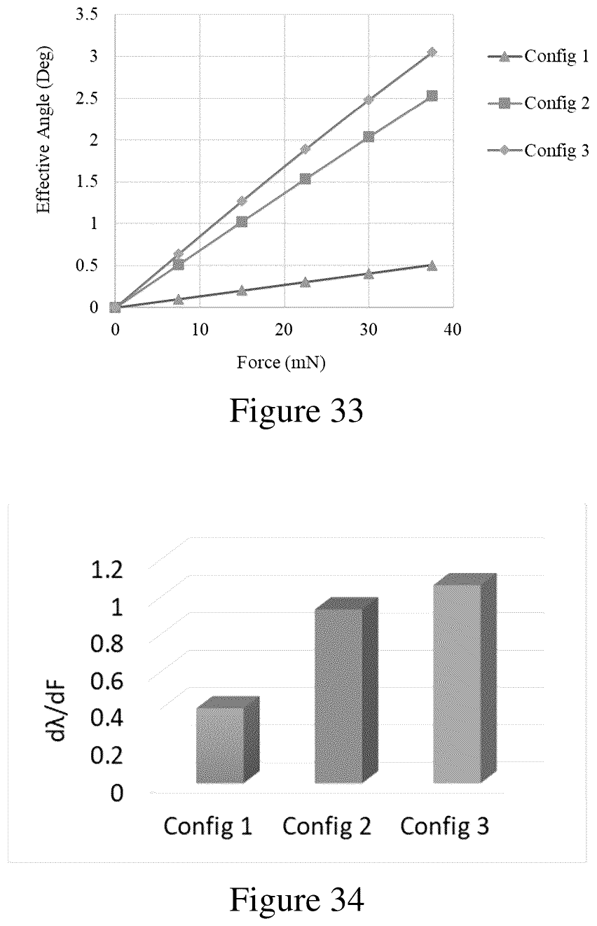

Perhaps a more critical comparison is comparing the effective change in angle of incident light to the grating and the device tunability. FIG. 33 illustrates the comparison of the change in the angle of incidence of light on the grating when different forces are applied.

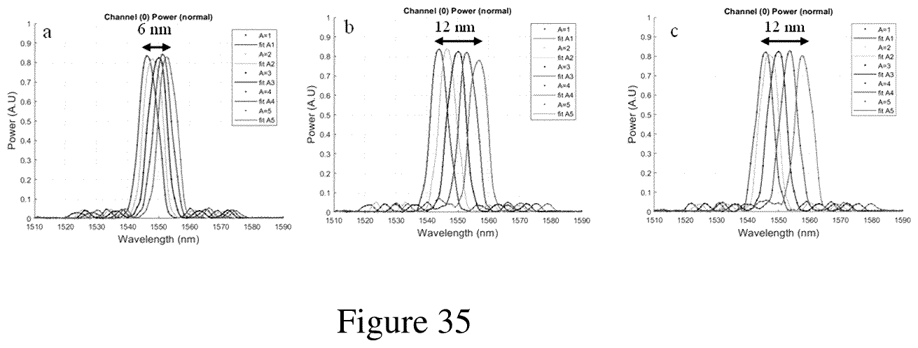

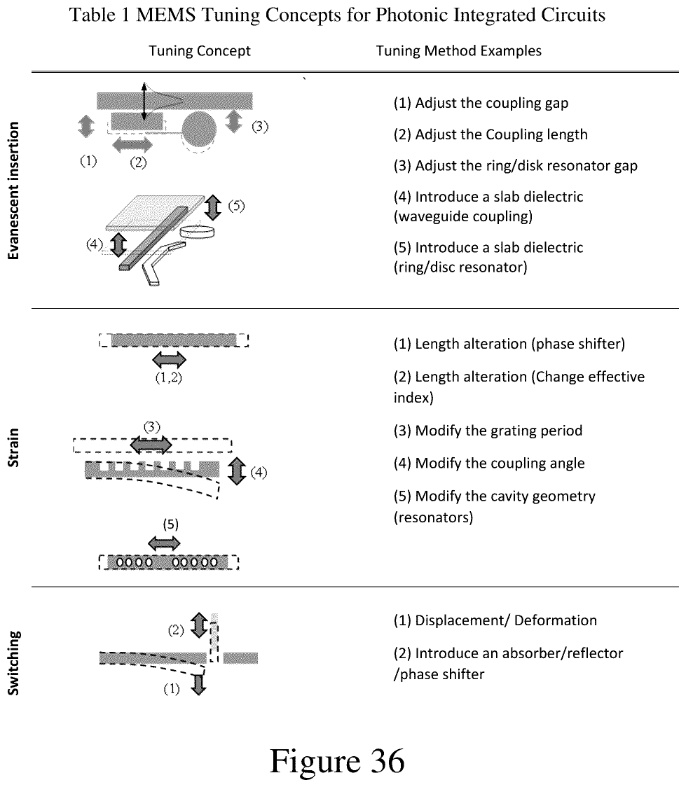

In the first configuration, the force applied to the junction of the rectangular part and the trapezoidal part of the slab waveguide causes movement and angular change at the entrance of the waveguides. The change in the angle of the waveguide input would send the light approximately towards the CDG center. Therefore, shifting the waveguide input causes a slight change in the angle of the incident light on the CDG, which is the origin of the modification of the output wavelengths. The first configuration provides a wavelength change of 0.4 nm per 1 mN of force in the simulated model. This means a tuning range of 6 nm for each channel with a force of 7.5 mN in both directions. (FIG. 35, a). In FIG. 35, a range of −7.5 mN to 7.5 mN is applied to a three-channel TOF. To show the tunability of the device, only the output power of the center channel is shown.

In the second configuration, the waveguide entry is fixed, but the CDG is shifting. Due to the bending of the trapezoidal part of the slab waveguide, the CDG experience a change in angle. Because of the lower rigidity of the waveguides, the change in angle of the incident light on the CDG increases by five times with the same applied force. The fivefold increase in the angle causes a twofold change in the tunability of the second configuration (FIG. 33). This is important to consider why the first configuration presents more tuning range with the same angle change. Since in the first configuration, both input and output angle change during the actuation, the output angle change will be more than the second configuration which the input is fixed. The second configuration provides a wavelength change of around 0.85 nm per 1 mN of force in the simulated model (FIG. 35, b), twice that of the first configuration.

In the third configuration, both the entry and CDG angles change together. However, the CDG angle change is more significant than the entry waveguide angle change because of bending in the trapezoidal part. In this design, the slab waveguide can rotate around the fixed part, making a less rigid waveguide. Consequently, this design shows more angle change for the same force (about six times that of the first configuration).

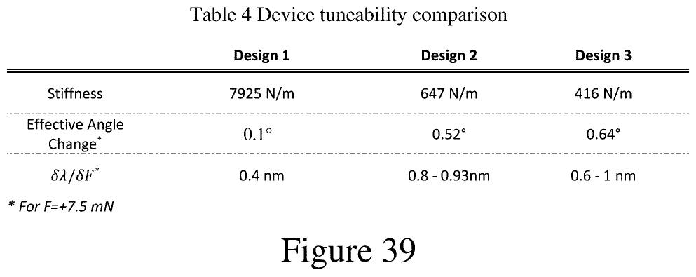

Although the method has the benefit of less stiffness and more tunability, it presents the drawback of asymmetrical behavior. If bilateral actuation is used to increase tunability, the third configuration offer less overall tunability than the second due to its asymmetrical behavior. This leads to a broader tuning range for longer wavelengths than shorter ones (FIG. 35, c). The main reason for the asymmetrical behavior is changing the angle of the entry waveguide and CDG in the same direction, which is evident in FIG. 35. This configuration offers a wavelength change between 0.6 nm and 1 nm per 1 mN of force, depending on the wavelength (FIG. 35, c). FIG. 34 shows the tunability comparison and FIG. 39 summarizes the comparison of the three presented configurations.

A comparison of different configurations is presented in FIG. 39. The second and third designs show more than two times more tuneability than the first configuration.

### REFERENCES

[1] M. P. Fok and J. Ge, “Tunable multiband microwave photonic filters,” Photonics, vol. 4, no. 4, 2017, doi: 10.3390/photonics4040045.
[2] K. Zhu, H. Zhu, and B. Mukherjee, “Optical WDM Networks,” p. 973, 2006.
[3] “Acousto-optic tunable filters,” G&H. https://gandh.com/product-categories/tunable-filters-aotf/ (accessed Jan. 16, 2022).
[4] TeraXion, “Ultra Narrowband Tunable Optical Filter,” TeraXion. https://www.teraxion.com/en/products/optical-communication s/ultra-narrowband-tunable-optical-filter/ (accessed Jan. 16, 2022).
[5] C. Errando-Herranz, A. Y. Takabayashi, P. Edinger, H. Sattari, K. B. Gylfason, and N. Quack, “MEMS for Photonic Integrated Circuits,” IEEE Journal of Selected Topics in Quantum Electronics, vol. 26, no. 2, pp. 1-16, March 2020, doi: 10.1109/JSTQE.2019.2943384.
[6] M. Stepanovsky, “A Comparative Review of MEMS-based Optical Cross-Connects for All-Optical Networks from the Past to the Present Day,” IEEE Communications Surveys & Tutorials, 2019.
[7] N. Quack et al., “MEMS-enabled Silicon Photonic Integrated Devices and Circuits,” IEEE Journal of Quantum Electronics, vol. 56, no. 1, pp. 1-10, 2019.
[8] M. Packirisamy and P. Pottier, “Wavelength tunable optical sources, filters and detectors,” U.S. Patent Application 2018/0,348,507 published Dec. 6, 2018
[9] P. Pottier and M. Packirisamy, “Micromechanically actuated deformable optical beam steering for wavelength tunable optical sources, filters and detectors,” U.S. Patent Application 2020/0,183,089 published Feb. 18, 2020
[10] M. Menard, F. Nabki, M. Rahim, J. Briere, and P.-O. Beaulieu, “Mirror based microelectromechanical systems and methods,” U.S. Patent Application 2020/0,219,818 published Jan. 14, 2020
[11] R. el Ahdab, S. Sharma, F. Nabki, and M. Ménard, “Wide-band silicon photonic MOEMS spectrometer requiring a single photodetector,” Opt. Express, OE, vol. 28, no. 21, pp. 31345-31359, October 2020, doi: 10.1364/OE.401623.
[12] J. Buus, M.-C. Amann, and D. J. Blumenthal, Tunable laser diodes and related optical sources. Hoboken, N.J.: Wiley-Interscience, 2005.
[13] Y. Xie et al., “Thermally-Reconfigurable Silicon Photonic Devices and Circuits,” IEEE Journal of Selected Topics in Quantum Electronics, vol. 26, no. 5, pp. 1-20, September 2020, doi: 10.1109/JSTQE.2020.3002758.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An optical device comprising:
a first region in which multiple optical beams are propagating.
a second region where at least one part of each optical beam of the multiple optical beams is received for further processing back into the first region; and
at least one third region between the first region and second region which is deformable without physical discontinuities with the first region and second region supporting oppositely propagating optical paths with more than one optical guiding features; wherein
the deformation of the third or second region results in the optical beam, received back in the third region having at least one of a different orientation and a different position than it initially had, after processing in the second region.

2. An optical device according to claim 1, wherein
at least one deformable third region is a mechanical beam supporting optical propagation.

3. An optical device according to claim 1, wherein
each optical beam is at least one of:
a diverging optical beam;
a converging optical beam;
a collimated optical beam;
a point source;
a guided optical beam.

4. An optical device according to claim 1, wherein
each optical beam is guided vertically using a planar waveguide.

5. An optical device according to claim 1, wherein
in a first part of a deformable region the optical beams are laterally guided;
in a second part of a deformable region the optical beams are laterally free to propagate resulting in control of the spatial properties of the optical beam within the second region.

6. An optical device according to claim 2, wherein
in a first part of the mechanical beam, the optical beams axis are parallel to mechanical beam axis;
in a second part of the mechanical beam, the optical beams axis does not follow the mechanical beam axis:
resulting in control of the spatial properties of the optical beam within the second region.

7. An optical device, according to claim 5, wherein
the first part of region three which the optical beams follow the deformation of the mechanical beam is fixed; and
the second region can freely move following the bend of the third region resulting in higher mechanical flexibility by reducing the overall slab waveguide stiffness.

8. An optical device according to claim 5, wherein
at least one anchor is placed in region three to fix the mechanical beam resulting in more control on the propagating beam angle in free lateral propagation area of third region.

9. An optical device according to claim 8, wherein
in the first part of the mechanical beam in the third region, the optical beams are guided to follow the mechanical beam deformation; and
in the second part of the mechanical beam in the third region the optical beams can propagate freely and the light paths do not follow the mechanical beam bent;

10. An optical device according to claim 2, wherein
the mechanical beam is a built-in beam;
a first part of the mechanical beam has a first second moment of inertia;
a second part of the mechanical beam has a second second moment of inertia resulting in control of the spatial properties of the optical beam within the second region.

11. An optical device according to claim 2, further comprising
an arrayed waveguide grating (AWG) with mirrors at the end of each AWG element is added on the end of the third region of the mechanical beam resulting in control of the spatial properties of the optical beam within the second region.

12. An optical device according to claim 2, further comprising
a diffraction grating, wherein
the angle of incidence or diffraction of light on or by the diffraction grating is controlled by the deformation of at least one mechanical beam resulting in a change of diffracted wavelengths

13. An optical device according to claim 12, wherein
one of the light inputs is a light output and the other light paths on region one are outputs or vice-versa; and
each output has specific tuning band based on the predetermined special position of the output waveguide.

14. An optical device according to claim 13, wherein
the center wavelength of the tuning band of each output is determined by a special separation of the outputs as a pre-set value.

15. An optical device according to claim 13, wherein
the device exit light could be light coming from one or a combination of lights paths come out from region one using reflectors at the end of desired channels resulting in a tunable wavelength and tunable bandwidth reflected.

16. An optical device according to claim 15, wherein
at least one device output connects to a laser gain medium to make one or several laser cavities resulting in a single or multi-band tunable diode laser.

17. An optical device according to claim 12, wherein
at least a part of the mechanical beam has a trapezoidal shape resulting in higher mechanical flexibility by removing parts where no optical beam is present.

18. An optical device according to claim 12, wherein
at least one of a spoiler region, Bragg grating and photonic crystal region is added and disposed laterally to the optical beam resulting in undesired parts of the optical beam not interfering with the desired parts.

19. An optical device according to claim 1, wherein
at least one deformable third region is deformed using micro-electro-mechanical systems.

20. An optical device according to claim 1, wherein
the at least one deformable third region is deformed using mechanical, electrical, magnetic, or piezo actuators, or with thermal deformation or with shape memory alloys.
